(19) United States
(12) Patent Application Publication
(10) Pub. No.: US 2011/0078446 A1
(43) Pub. Date: Mar. 31, 2011

(54) SYSTEM AND METHOD FOR DEPLOYING A MASTER KEY BETWEEN TWO COMMUNICATION DEVICES

(75) Inventors: CONG HE, Shanghai (CN); CHI-MING LU, Tu-Cheng (TW); GUO-ZHI DING, Shanghai (CN)

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/696,151

(22) Filed: Jan. 29, 2010

(30) Foreign Application Priority Data
Sep. 29, 2009 (CN) 200910308003.0

(51) Int. Cl. H04L 9/32; H04L 9/08; H04L 9/14

(52) U.S. Cl. 713/171; 380/47; 380/283; 380/270

(57) ABSTRACT

A system and method of deploying a master key for a first communication device and second communication device. The first communication device receives a request message from the second communication device through a wireless communication network, and creates a master key algorithm based on configuration parameters of the request message. The first communication device further generates a master key according to the master key algorithm, verifies whether the master key created by the first communication device is correct, and installs the master key in the first and second communication devices when the master key is correct.

### BACKGROUND

1. Technical Field

Embodiments of the present disclosure relate generally to wireless communication systems, and more particularly to a system and method for dynamically deploying a master key between two communication devices.

2. Description of Related Art

In spite of mobility and convenience improvements in wireless communication systems, security concerns limit or prevent their use in most corporate environments. Therefore, it is a priority to introduce a wireless communication system having improved security.

In order to improve the security of the wireless communication system, wireless communication devices require use of a master key (MK) to generate a pair-wise temporal key (PTK) before encrypting data transmitted in security mode. However, communication devices from different vendors do not share mutual secure connections, such that the security of such wireless communication systems is insufficient once the MK is cracked.

Accordingly, there is a need for an improved system and method for dynamically deploying a master key between two communication devices, so as to overcome the limitations described.

### BRIEF DESCRIPTION OF THE DRAWINGS

FIG. 1 is a schematic diagram of one embodiment of a master key deployment system.

FIG. 2 is a block diagram of function modules of the master key deployment system of FIG. 1.

FIG. 3 is a flowchart of one embodiment of a method for deploying a master key between two communication devices using a master key deployment system, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

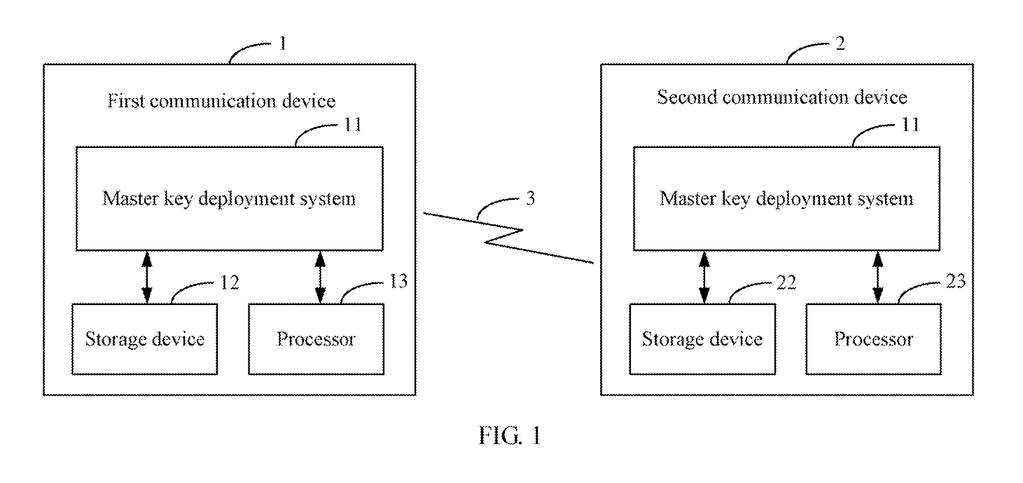

FIG. 1 is a schematic diagram of one embodiment of a master key deployment system 11. In the embodiment, the master key deployment system 11 can dynamically deploy master keys of a plurality of communication devices. As an example, two communication devices are shown in FIG. 1, such as a first communication device 1 and a second communication device 2. The first communication device 1 can communicate with the second communication device 2 through a wireless communication network 3, such as a global system for mobile communications (GSM) network, or a general packet radio service (GPRS) network, for example. The first communication device 1 and the second communication device 2 may be mobile phones, desktop computers, laptop computers, handheld, or any other suitable communication devices. In the embodiment, both of the communication devices employ the master key deployment system 11 as disclosed.

Each of the first communication device 1 and the second communication device 2 may include a storage device 12, and at least one processor 13. In one embodiment, the master key deployment system 11 may be stored in the storage device 12 or a computer readable medium of the two communication devices. In another embodiment, the master key deployment system 11 may be included in an operating system of the two communication devices, such as an embedded operating system, or any other compatible operating system. The storage device 12 may be an internal storage device, such as a random access memory (RAM) for temporary storage of information and/or a read only memory (ROM) for permanent storage of information. The storage device 12 may also be an external storage device, such as a hard disk, a storage card, or a data storage medium.

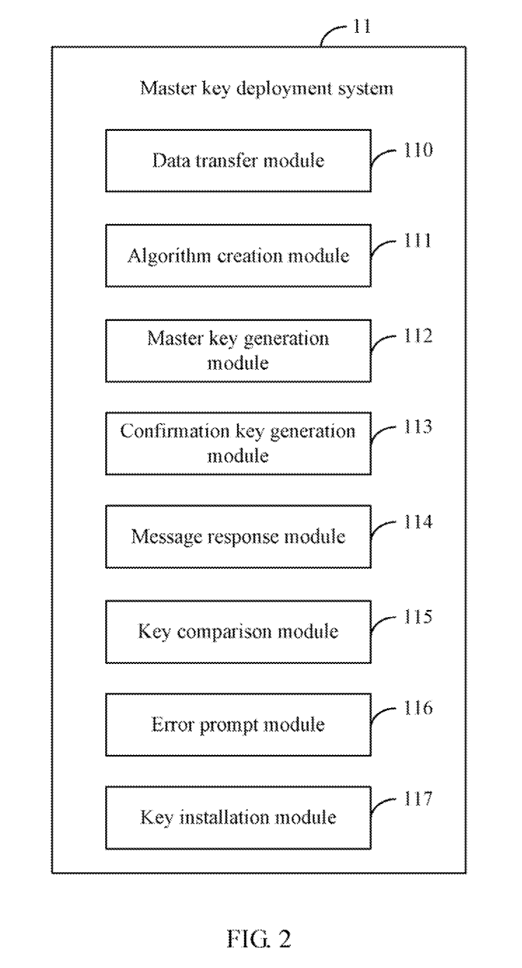

FIG. 2 is a block diagram of function modules of the master key deployment system 11 in FIG. 1. In one embodiment, the master key deployment system 11 includes a data transfer module 110, an algorithm creation module 111, a master key generation module 112, a confirmation key generation module 113, a message response module 114, a key comparison module 115, an error prompt module 116, and a key installation module 117. One or more computerized codes of the function modules 110-117 may be stored in the storage device 12 and executed by the at least one processor 13. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. The modules described herein may be implemented as either software and/or hardware modules and may be stored in any type of computer-readable medium or other storage device.

The data transfer module 110 is operable to receive a request message from the second communication device 2 through the wireless communication network 3 when the second communication device 2 sends the request message to the first communication device 1. The request message requests the first communication device 1 to create a master key of the second communication device 2, such as a CREATE_MK_REQUEST message, for example. The request message may include a plurality of configuration parameters for creating the master key of the second communication device 2.

The algorithm creation module 111 is operable to create an intermediate key algorithm and a master key algorithm based on the configuration parameters of the request message. For example, the algorithm creation module 111 may use the configuration parameters PRF-256 (K, N, A, B, Blen) to create each of the key algorithms, wherein “K” denotes a 256-bit key, “N” denotes a 13-octet nonce value, “A” denotes a unique 14-octet ASCII text label for each different use of the PRF, “B” denotes an input data stream, and “Blen” specifies the length of the data stream.

The master key generation module 112 is operable to generate an intermediate key based on the configuration parameters according to the intermediate key algorithm. In one embodiment, the key generation module 112 generates the intermediate key according to the following descriptions: MIK=PRF-256 (K, N, A, B, Blen), “K” denotes a previous MK, “N” denotes “B12−11=Second DevAddr, B10−9=First DevAddr, B8−0=zero”, “A” denotes “Update-New-Key”, “B” denotes fields from Specifier ID to Status, and “Blen” specifies 52.

The master key generation module 112 is further operable to generate a master key based on the intermediate key according to the master key algorithm. In one embodiment, the key generation module 112 generates the master key according to the following descriptions: MK=PRF-256 (K, N, A, B, Blen), wherein “K” denotes a previous MK, “N” denotes “B12−11=Second communication DevAddr, B10−9=Master DevAddr, B8−0=zero”, “A” denotes “MK-Auto-Deploy”, “B” denotes the intermediate key, “Blen” specifies 32.

The confirmation key generation module 113 is operable to generate a confirmation key based on the intermediate key according to a confirmation key algorithm, such as a Diffe-Hellman (DH) algorithm, for example. In one embodiment, the confirmation key generation module 113 generates the confirmation key according to the following descriptions: PK=Yi or Xi (mod p), where “p” is a first DH parameter, “Xi” is a secret 256-bits random number defined as (Xi<p−1), “Yi” is the intermediate key defined as Yi=g or Xi (mod p), and “g” is a second DH parameter.

The message response module 114 is operable to generate a response message, such as a CREATE_MK_RESPONSE message when the confirmation key is generated, and send the response message to the second communication device 2 through the wireless communication network 3. The message response module 114 is further operable to receive a verification code from the second communication device 2 after the response message is received by the second communication device 2. In one embodiment, the verification code is predefined by the second communication device 2. The verification code is used to verify whether the master key generated by the first communication device 1 is correct.

The key comparison module 115 is operable to determine whether the confirmation key is identical to the verification code. If the confirmation key is not identical to the verification code, the error prompt module 116 generates an error message indicating that the master key has not been created successfully, and issues the error message to the second communication device 2 through the wireless communication network 3. The master key installation module 117 is operable to send the master key to the second communication device 2 and install the master key in the second communication device 2 when the confirmation key is identical to the verification code.

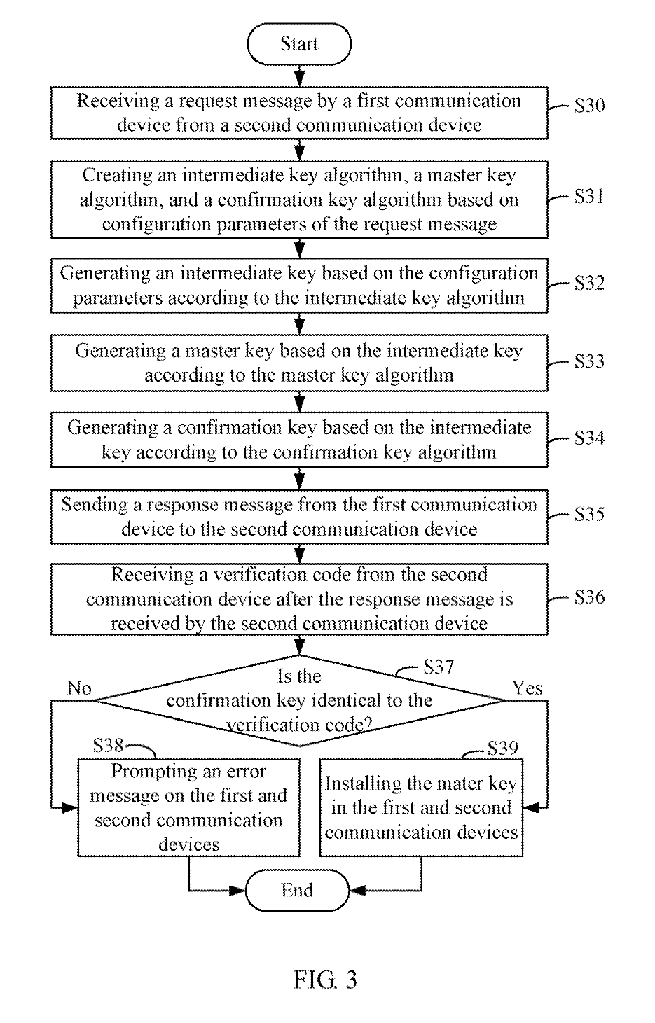

FIG. 3 is a flowchart of one embodiment of a method for dynamic deployment of a master key between two communication devices using a master key deployment system, such as, for example, that of FIG. 1. Depending on the embodiment, additional blocks may be added, others removed, and the ordering of the blocks may be changed.

In block S30, the data transfer module 110 receives a request message by the first communication device 1 from the second communication device 2 through the wireless communication network 3. The request message requests the first communication device 1 to allocate a master key of the second communication device 2, such as a CREATE_MK_REQUEST message. The request message may include a plurality of configuration parameters for creating the master key of the second communication device 2.

In block S31, the algorithm creation module 111 creates an intermediate key algorithm and a master key algorithm based on configuration parameters of the request message. For example, the algorithm creation module 111 uses configuration parameters PRF-256(K, N, A, B, Blen) to create each of the key algorithms, where “K” denotes a 256-bit key, “N” denotes a 13-octet nonce value, “A” denotes a unique 14-octet ASCII text label for each different use of the PRF, “B” denotes an input data stream, and “Blen” specifies the length of the data stream.

In block S32, the master key generation module 112 generates an intermediate key based on the configuration parameters according to the intermediate key algorithm. In one embodiment, the key generation module 112 generates the intermediate key according to the following descriptions: MIK=PRF-256 (K, N, A, B, Blen), “K” denotes a previous MK, “N” denotes “B12−11=Second communication DevAddr, B10−9=Master DevAddr, B8−0=zero”, “A” denotes “Update-New-Key”, “B” denotes fields from Specifier ID to Status, and “Blen” specifies 52.

In block S33, the master key generation module 112 generates a master key based on the intermediate key according to the master key algorithm. In one embodiment, the key generation module 112 generates the master key according to the following descriptions: MK=PRF-256 (K, N, A, B, Blen), where “K” denotes a previous MK, “N” denotes “B12−11=Second communication DevAddr, B10−9=Master DevAddr, B8−0=zero”, “A” denotes “MK-Auto-Deploy”, “B” denotes the intermediate key, “Blen” specifies 32.

In block S34, the confirmation key generation module 113 generates a confirmation key based on the intermediate key according to a confirmation key algorithm, such as a Diffe-Hellman (DH) algorithm, for example. In one embodiment, the confirmation key generation module 113 generates the confirmation key according to the following descriptions: PK=Yi or Xi (mod p), where “p” is a first Diffe-Hellman (DH) parameter, “Xi” is a secret 256-bits random number defined as (Xi<p−1), “Yi” is the intermediate key defined as Yi=g or Xi (mod p), and “g” is a second DH parameter.

In block S35, the message response module 114 generates a response message, such as a CREATE_MK_RESPONSE message, when the confirmation key is generated, and transmits the response message to the second communication device 2 through the wireless communication network 3. In block S36, the message response module 114 receives a verification code from the second communication device 2 after the response message is received by the second communication device 2. In one embodiment, the verification code is predefined by the second communication device 2. The verification code is used to verify whether the master key created by the first communication device 1 is correct.

In block S37, the key comparison module 115 determines whether the confirmation key is identical to the verification code. If the confirmation key is not identical to the verification code, in block S38, the error prompt module 116 generates an error message indicating that the master key is not created successfully, and displays the error message on the first communication device 1 and the second communication device 2. Otherwise, if the confirmation key is identical to the verification code, in block S39, the master key installation module 117 installs the master key in the first communication device 1 and the second communication device 2.

All of the processes described may be embodied in, and fully automated via, functional code modules executed by one or more general purpose processors of a computing device. The functional code modules may be stored in any type of readable medium or other storage devices. Some or all of the methods may alternatively be embodied in specialized computing devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for deploying a master key between a first communication device and a second communication device, each of the two communication devices comprising:
a storage device; and
at least one processor that executes one or more programs stored in the storage device, the one or more programs comprising:
a data transfer module operable to receive a request message by the first communication device from the second communication device through a wireless communication network;
an algorithm creation module operable to create an intermediate key algorithm, a master key algorithm, and a confirmation key algorithm according to configuration parameters of the request message;
a master key generation module operable to generate an intermediate key based on the configuration parameters according to the intermediate key algorithm, and generate a master key based on the intermediate key according to the master key algorithm;
a confirmation key generation module operable to generate a confirmation key based on the intermediate key according to the confirmation key algorithm;
a message response module operable to send a response message to the second communication device through the wireless communication network, and receive a verification code from the second communication device after the response message is received by the second communication device; and
a master key installation module operable to install the master key in the first communication device and the second communication device when the confirmation key is identical to the verification code.

2. The system according to claim 1, further comprising a key comparison module operable to compare the confirmation key with the verification code to determine whether the confirmation key is identical to the verification code.

3. The system according to claim 2, further comprising an error prompt module operable to generate an error message when the confirmation key is not identical to the verification code, and display the error message on the first and second communication device.

4. The system according to claim 3, wherein the error message indicates that the master key is not created successfully.

5. The system according to claim 1, wherein the request message requests the first communication device to allocate the master key to the second communication device.

6. The system according to claim 1, wherein the verification code is predefined by the second communication device, and verifies whether the master key created by the first communication device is correct.

7. A method for deploying a master key between two communication devices, the method comprising:
receiving a request message by a first communication device from a second communication device through a wireless communication network;
creating an intermediate key algorithm, a master key algorithm, and a confirmation key algorithm based on configuration parameters of the request message;
generating an intermediate key based on the configuration parameters according to the intermediate key algorithm;
generating a master key based on the intermediate key according to the master key algorithm;
generating a confirmation key based on the intermediate key according to the confirmation key algorithm;
sending a response message from the first communication device to the second communication device through the wireless communication network;
receiving a verification code generated by the second communication device after the response message is received by the second communication device;
determining whether the confirmation key is identical to the verification code; and
installing the master key in the first communication device and the second communication device if the confirmation key is identical to the verification code.

8. The method according to claim 7, further comprising:
generating an error message if the confirmation key is not identical to the verification code; and
displaying the error message on the first communication device and the second communication device.

9. The method according to claim 8, wherein the error message indicates that the master key is not created successfully by the first communication device.

10. The method according to claim 7, wherein the request message requests the first communication device to allocate the master key to the second communication device.

11. The method according to claim 7, wherein the verification code is predefined by the second communication device, and verifies whether the master key created by the first communication device is correct.

12. A storage medium having stored thereon instructions that, when executed by a processor of a computing device, cause the computing device to perform a method for deploying a master key of a communication device, the method comprising:
receiving a request message from the communication device through a wireless communication network;
creating an intermediate key algorithm, a master key algorithm, and a confirmation key algorithm based on configuration parameters of the request message;
generating an intermediate key based on the configuration parameters according to the intermediate key algorithm;
generating a master key based on the intermediate key according to the master key algorithm;
generating a confirmation key based on the intermediate key according to the confirmation key algorithm;
sending a response message to the communication device through the wireless communication network;
receiving a verification code from the communication device after the response message is received by the communication device;
determining whether the confirmation key is identical to the verification code; and
installing the master key in the communication device if the confirmation key is identical to the verification code.

13. The storage medium according to claim 12, wherein the method further comprises:
generating an error message if the confirmation key is not identical to the verification code; and
sending the error message to the communication device through the wireless communication network.

14. The storage medium according to claim 13, wherein the error message indicates that the master key is not created successfully by the computing device.

15. The storage medium according to claim 12, wherein the request message requests the computing device to allocate the master key to the communication device.

16. The storage medium according to claim 12, wherein the verification code is predefined by the communication device, and verifies whether the master key created by the computing device is correct.
